(19) United States
(12) Patent Application Publication
(10) Pub. No.: US 2026/0094110 A1
(43) Pub. Date: Apr. 2, 2026

(54) SYSTEMS AND METHODS FOR CARGO VEHICLE ASSET MANAGEMENT

(71) Applicant: Wabash National, L.P., Lafayette, IN (US)

(72) Inventors: Cory O'Brien, Lafayette, IN (US); Mitchell Baker, Mount Prospect, IL (US)

(73) Assignee: Wabash National, L.P., Lafayette, IN (US)

(21) Appl. No.: 19/334,129

(22) Filed: Sep. 19, 2025

Related U.S. Application Data
(60) Provisional application No. 63/700,137, filed on Sep. 27, 2024.

(51) Int. Cl. G06Q 10/083; G06Q 10/0631

(52) U.S. Cl. CPC G06Q 10/083; G06Q 10/06315

(57) ABSTRACT

A method of resource orchestration for cargo vehicles includes receiving a plurality of user inputs, the plurality of inputs including geographical data associated with a lane of travel and a desired volume of assets for traveling on the lane of travel. The method further comprising obtaining a plurality of data sets, the plurality of data sets including a first data set associated with the lane of travel and a second data set associated with a pool of assets. Further, generating, based upon the plurality of data sets and the plurality of user inputs, a proposed resource allocation including a proposed volume of assets for traveling on the lane of travel, and providing, to a user computing device, an indication of the proposed resource allocation for display to a user of the user computing device.

### CROSS-REFERENCE TO RELATED APPLICATION

The present application claims the benefit of U.S. Provisional Patent Serial Application No. 63/700,137, filed Sep. 27, 2024, the entire disclosure of which is expressly incorporated herein by reference.

### FIELD OF THE DISCLOSURE

The present disclosure relates to managing asset capacity for cargo vehicles such as trailers, truck bodies, and the like.

### BACKGROUND OF THE DISCLOSURE

Transporting cargo between locations requires multiple resources to determine cargo vehicle availability, insurance requirements, etc. Such resource allocation may require manual determination of lanes and trailer availability from a plurality of providers which may result in inefficient resource allocation. Further, it may be difficult to obtain exact pricing for such cargo shipments, as information is required from multiple sources and/or the customer may not accurately calculate all costs associated with various cargo shipments. As such, there is a need for a single resource which may receive inputs related to cargo to be transported and connects such inputs with outputs used to reserve and facilitate the necessary cargo vehicles and associated resources.

### SUMMARY OF THE DISCLOSURE

In embodiments of the present disclosure, a method of resource orchestration for cargo vehicles is provided. The method comprising, receiving a plurality of user inputs, the plurality of inputs including geographical data associated with a lane of travel and a desired volume of assets for traveling on the lane of travel. The method further comprising obtaining a plurality of data sets, the plurality of data sets including a first data set associated with the lane of travel and a second data set associated with a pool of assets and generating, based upon the plurality of data sets and the plurality of user inputs, a proposed resource allocation including a proposed volume of assets for traveling on the lane of travel. The method further comprising providing, to a user computing device, an indication of the proposed resource allocation for display to a user of the user computing device.

In embodiments, the method further comprises receiving, from the user computer device, an acceptance of the proposed resource allocation, generating a reservation including a reserved volume of assets based upon the proposed volume of assets from the pool of assets, and providing, to the user computing device, an indication of the reserved volume of assets for display to a user of the user computing device.

In embodiments, the generating a reservation step further comprises generating a timestamp representative of a period of time for the volume of assets, and marking the volume of assets as unavailable for the period of time.

In embodiments, the pool of assets includes a first asset in a first region and a second asset in a second region.

In embodiments, the plurality of data sets includes information about a location of an asset of the pool of assets.

In embodiments, the method further comprises determining, based upon a first location of a first asset of the pool of assets and a second location of a second asset of the pool of assets, a relative proximity score of each of the first asset and the second asset. Further, wherein the generated proposed resource allocation includes at least one of the first asset and the second asset based upon the determined proximity score of each of the first asset and the second asset.

In embodiments, the method further comprises determining, based upon at least one data set of the plurality of data sets, a relative utilization score of each of the first asset and the second asset. Further, wherein the generated proposed resource allocation includes at least one of the first asset and the second asset based upon the determined utilization score of each of the first asset and the second asset.

In yet another embodiment of the present disclosure, a system is provided. The system comprising at least one processor, and a memory comprising instructions that, when executed by the at least one processor, cause the system to perform a set of operations. The set of operations comprise receiving a plurality of user inputs, the plurality of inputs including geographical data associated with a lane of travel and a desired volume of assets for traveling on the lane of travel and obtaining a plurality of data sets, the plurality of data sets including a first data set associated with the lane of travel and a second data set associated with a pool of assets. The set of operations further comprising generating, based upon the plurality of data sets and the plurality of user inputs, a proposed resource allocation including a proposed volume of assets for traveling on the lane of travel, and providing, to a user computing device, an indication of the proposed resource allocation for display to a user of the user computing device.

In embodiments, the set of operations further comprises receiving, from the user computing device, an acceptance of the proposed resource allocation and generating a reservation including a reserved volume of assets based upon the proposed volume of assets from the pool of assets. The set of operations further comprises providing, to the user computing device, an indication of the reserved volume of assets for display to a user of the user computing device.

In embodiments, the generating a reservation step of the set of operations further comprises generating a timestamp representative of a period of time for the volume of assets; and marking the volume of assets as unavailable for the period of time.

In embodiments, the plurality of data sets includes a location of an asset of the pool of assets.

In embodiments, the proposed volume of assets is equal to or less than the desired volume of assets.

In embodiments, the set of operations further comprises determining, based upon a first location of a first asset of the pool of assets and a second location of a second asset of the pool of assets, a relative proximity score of each of the first asset and the second asset. Further, wherein the generated proposed resource allocation includes at least one of the first asset and the second asset based upon the determined proximity score of each of the first asset and the second asset.

In embodiments, the set of operations further comprises determining, based upon at least one data set of the plurality of data sets, a relative utilization score of each of the first asset and the second asset. Further, wherein the generated proposed resource allocation includes at least one of the first asset and the second asset based upon the determined utilization score of each of the first asset and the second asset.

In yet another embodiment of the present disclosure, a method of resource orchestration for cargo vehicles is provided. The method comprises receiving a plurality of user inputs, the plurality of inputs including an origin and a destination associated with a lane of travel and a desired volume of assets for traveling on the lane of travel and obtaining a plurality of data sets, the plurality of data sets including a first data set associated with location data of a pool of assets. The pool of assets includes a first asset positioned at a first location spaced a first distance from the origin and a second asset positioned at a second location spaced a second distance from the origin. The method further comprises determining, based upon the first distance and the second distance, a respective proximity score for each of the first asset and the second asset and generating, based upon the plurality of data sets, the plurality of user inputs, and the proximity score of each of the first asset and the second asset, a proposed resource allocation including a proposed volume of assets for traveling on the lane of travel. Further, the proposed volume of assets includes at least one of the first asset and the second asset. The method further comprises providing, to a user computing device, an indication of the proposed resource allocation for display to a user of the user computing device.

In embodiments, the proximity score is further based upon a respective navigable time between the origin and each of the first location and the second location.

In embodiments, the proximity score is further based upon a respective earliest asset arrival time of each of the first asset and the second asset.

In embodiments, the method further comprises receiving, from the user computing device, an acceptance of the proposed resource allocation and generating a reservation including a reserved volume of assets based upon the proposed volume of assets from the pool of assets. Further, providing, to the user computing device, an indication of the reserved volume of assets for display to a user of the user computing device.

In embodiments, the generating a reservation step of the set of operations further comprises generating a timestamp representative of a period of time for the volume of assets and marking the volume of assets as unavailable for the period of time.

In embodiments, the proposed volume of assets is equal to or less than the desired volume of assets.

### BRIEF DESCRIPTION OF THE DRAWINGS

FIG. 1 illustrates a system diagram of a system of the present disclosure;

FIG. 2A illustrates a first portion of a method of the present disclosure;

FIG. 2B illustrates a second portion of the method of FIG. 2A;

FIG. 2C illustrates a third portion of the method of FIG. 2A;

FIG. 3 illustrates a fourth portion of the method of FIG. 2A;

FIG. 4A illustrates a method of generating a reservation of the present disclosure;

FIG. 4B illustrates a method of determining a proximity score of an asset of the present disclosure;

FIG. 4C illustrates a method of determining a utilization score of an asset of the present disclosure;

FIG. 4D illustrates a method of determining a total score of an asset of the present disclosure;

FIG. 5 illustrates a first screen layout for a display of the system of FIG. 1;

FIG. 6A illustrates a second screen layout for a display of the system of FIG. 1;

FIG. 6B illustrates an alternate second screen layout for a display of the system of FIG. 1;

FIG. 7 illustrates a third screen layout with a confirmation page for a display of the system of FIG. 1;

FIG. 8 illustrates a fourth screen layout for a display of the system of FIG. 1 showing a first portion of the fourth screen layout;

FIG. 9 illustrates the fourth screen layout for a display of the system of FIG. 1 showing a second portion of the fourth screen layout;

FIG. 10 illustrates the fourth screen layout for a display of the system of FIG. 1 showing a third portion of the fourth screen layout;

FIG. 11 illustrates the fourth screen layout for a display of the system of FIG. 1 showing a fourth portion of the fourth screen layout;

FIG. 12 illustrates a fifth screen layout for a display of the system of FIG. 1;
and

FIG. 13 illustrates an example system diagram that may be used to operate systems and methods of the present disclosure.

### DETAILED DESCRIPTION OF THE DRAWINGS

For the purposes of promoting an understanding of the principles of the present disclosure, reference is now made to the embodiments illustrated in the drawings, which are described below. The embodiments disclosed below are not intended to be exhaustive or limit the present disclosure to the precise form disclosed in the following detailed description. Rather, the embodiments are chosen and described so that others skilled in the art may utilize their teachings. Therefore, no limitation of the scope of the present disclosure is thereby intended. Corresponding reference characters indicate corresponding parts throughout the several views.

In some instances throughout this disclosure and in the claims, numeric terminology, such as first, second, third, and fourth, is used in reference to various operative transmission components and other components and features. Such use is not intended to denote an ordering of the components. Rather, numeric terminology is used to assist the reader in identifying the component being referenced and should not be narrowly interpreted as providing a specific order of components.

In some instances throughout this disclosure, methods are described including a variety of steps or processes. It should be understood that the described steps and the described order are not limiting, and the steps may be completed in any appropriate order understood by those skilled in the art. Additionally, those skilled in the art may recognize that not all steps are required at all times.

When transporting cargo between locations, it is necessary to coordinate and schedule the types of cargo vehicles needed for the cargo, the availability of the cargo vehicles, fuel needed, maintenance costs, insurance, and many other factors. This process can be time consuming and inaccurate. More particularly, present methods for orchestrating resources for transportation and logistics operations may include a customer manually searching for individual lanes or bulk shipping lanes and determining the cost of the individual or bulk shipping lane(s) based upon one or more data sets. Lanes may be considered the path of travel of a cargo trailer between an origin and a destination, and a lane may also include recurring trips to haul cargo at recurring intervals. A customer may know or have an estimation of the assets (e.g., trailers) anticipated to satisfy their requirements. However, the customer may not know the volume of assets anticipated and/or available to satisfy their requirements. As such, the present disclosure relates to a system and method which obtains inputs that enable a logistics provider to calculate the volume of assets anticipated to satisfy a customer's transportation freight needs. The resource orchestration method of the present disclosure may output a resource allocation including the volume of assets anticipated, a trailer cost, a fuel cost, a driver cost, and other costs to provide a single anticipated resource allocation and an anticipated cost for the consumer.

The system and method for resource orchestration disclosed herein provides an efficient and cost-effective allocation of resources by aggregating customer data and inputs as well as external data sources to create a single proposed resource allocation including anticipated asset allocation and an anticipated asset cost for the consumer. Resource orchestration using customer inputs and data reduces costs, creates more accurate asset allocation volumes, and gives the customer greater control over the requested resource allocation.

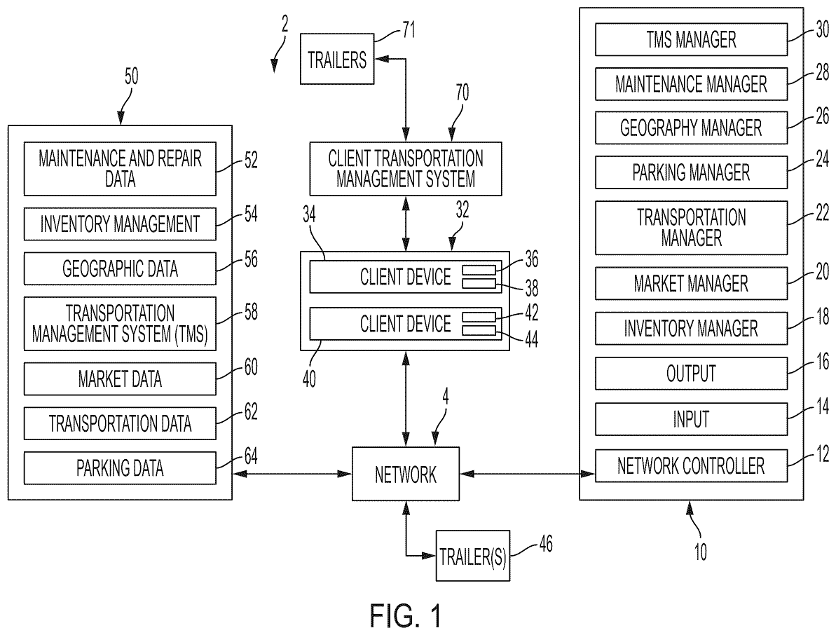

Referring to FIG. 1, an example system 2 includes a network 4. System 2 further includes a computer environment or server device 10, a client device 32 (e.g., a customer device), one or more data sources 50, and a plurality of cargo vehicles 46, referred to herein as trailers but also may include tanks, truck bodies, vans, and any other type of cargo vehicle/container, communicably coupled to network 4. Network 4 may be a wireless network or a wired network, and may be a Wi-Fi network, a Bluetooth network, a cellular network, or another type of network. In embodiments, server device 10 includes a network controller 12 operably coupled to the network 4, at least one input 14, and at least one output 16. In embodiments, input 14 may include a cursor control, a touch input, a keyboard input, a discrete input, a continuous input, or another type of input. Output 16 may include a display such as a computer display, a mobile device display, an analog display, a digital display, or another type of display. Referring still to FIG. 1, server device 10 includes an inventory manager 18, a market manager 20, a transportation manager 22, a parking manager 24, a geography manager 26, a maintenance manager 28, and a transportation management system (TMS) manager 30. In embodiments, server device 10 may be a single device or may be a distributed device among a plurality of devices. In embodiments, one or more of the inventory manager 18, market manager 20, transportation manager 22, parking manager 24, geography manager 26, maintenance manger 28, and TMS manager 30 are embodied on a controller which may be a single controller or a distributed controller.

System 2 includes one or more client devices 32 operably coupled to network 4 and server device 10. Client device 32 may include a first client device 34 including an input 36 and an output 38 and a second client device 40 including an input 42 and an output 44. In embodiments, inputs 36, 42 may include a cursor control, a touch input, a keyboard input, a discrete input, a continuous input or another type of input. In embodiments, outputs 38, 44 may include a computer display, mobile device display, analog display, digital display, or another type of display. In embodiments, at least one client device 32 of the one or more client devices 32 is operably coupled to a client transportation management system 70. In embodiments, the one or more client devices 32 may be a mobile device, a personal computer, or another device.

Still referring to FIG. 1, system 2 includes the plurality of data sources 50 operably coupled to server device 10 by network 4. Data sources 50 may include data related to the plurality of trailers 46, or a pool of assets 46, or may also include auxiliary data associated with the plurality of trailers 46 or the lanes requested by a customer. In embodiments, the plurality of data sources 50 includes a maintenance and repair data source 52, an inventory management data source 54, a geographic data source 56, a transportation management system (TMS) data source 58, a market data source 60, a transportation data source 62, and a parking data source 64. In embodiments, transportation management system (TMS) data source 58 may include real-time trailer data including trailer availability, trailer location, trailer status, and may include other trailer data. Maintenance and repair data source 52 may include real-time data regarding the health status, maintenance status, downtime, cost to repair, or other data regarding one or more of the plurality of trailers 46. Inventory management system 54 may include real-time data regarding the number of trailers of the plurality of trailers 46 that are currently available, the number of trailers of the plurality of trailers 46 that are available in the future, positioning data regarding the plurality of trailers 46 (e.g., past position, current position, or future position), and other data. Geographic data 56 may include data such as roads, directions, stoplights, freeways, highways, tolls and may also include elevation changes, weather data, and other relevant geographic data. In embodiments, market data source 60 may include current and/or market pricing of other trailers on the market. Market data source 60 may also include market pricing of drivers, market pricing of insurance, and market price of fuel. Transportation data 62 may include road closures, detours, fuel prices and/or locations (e.g., gas stations) and other transportation data. Parking data 64 may include locations of available parking lots, cost of parking lots, and other parking related data. In embodiments, data sources 50 could be a single data source. In embodiments, data sources 50 could be a plurality of data sources.

In embodiments, the plurality of data sources 50 include data obtained from partnerships with third party data providers such that server device 10 may obtain, e.g., by network 4, real-time pricing, asset cost, availability, and other information from each of data sources 50. In embodiments, client device(s) 32 may obtain data from data sources 50 directly from network 4.

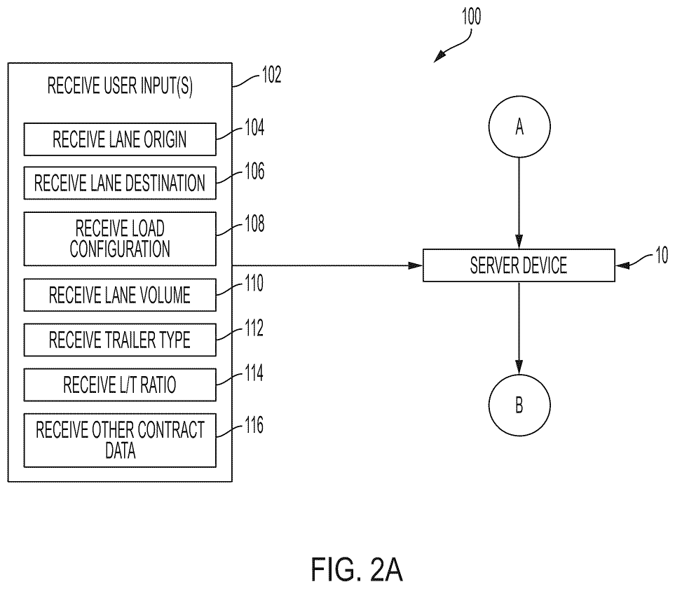

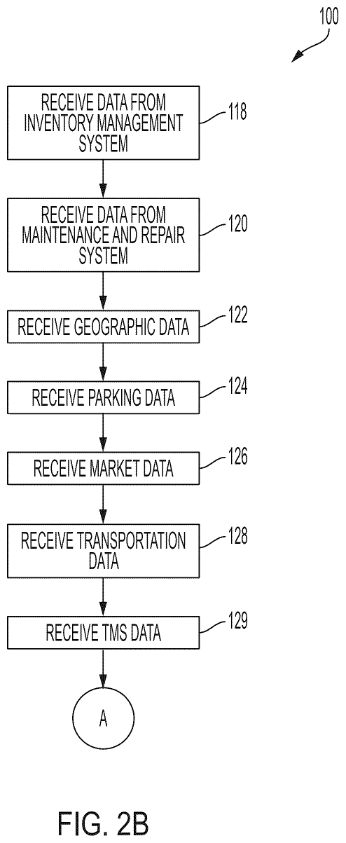

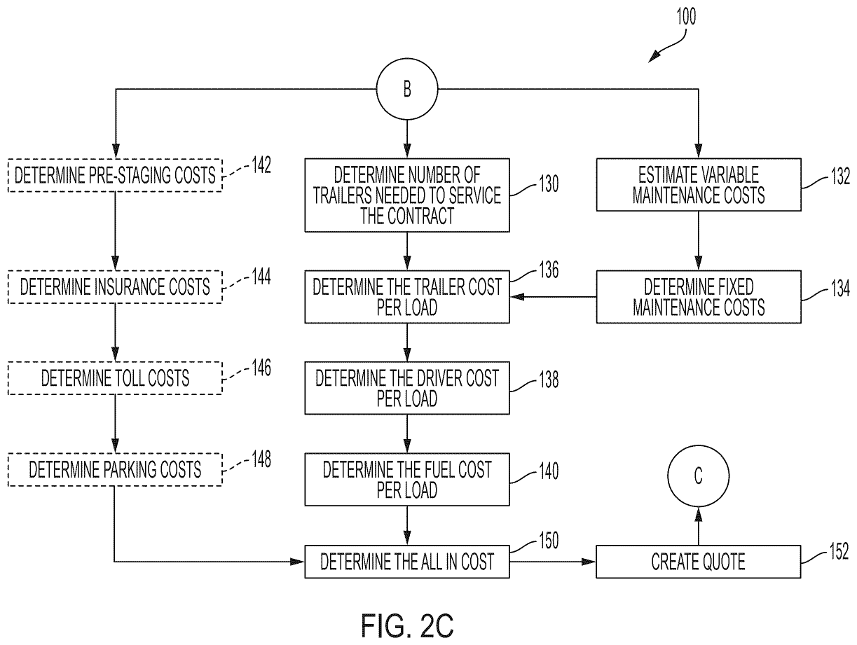

Referring now to FIGS. 1-2, one or more inputs may be obtained at first client device 34 (e.g., at input 36) and communicated by network 4 to server device 10. User inputs at input 36 may be touch inputs, keyboard inputs, voice inputs, cursor inputs, or other types of inputs.

In embodiments, first client device 34 is used by, or representative of, a customer seeking to find cargo vehicles, such as trucks and/or trailers, to transport cargo along a lane. A customer may search for one or more lanes that a logistics provider can guarantee to the customer. The logistics provider may have a plurality of trailers 46 capable of satisfying the lanes requested by the customer. The trailers 46 may be positioned throughout a region, throughout a plurality of states, or across the country. An example method 100 for resource orchestration is described below that obtains data from multiple data sources, including from the customer, the logistics provider, and/or third party data sources, to seamlessly calculate a proposed resource allocation (e.g., proposed costs and volume of assets) for the customer to use. It may be appreciated that method 100 and system 2 provide a single customer platform or dashboard by which the customer can provide inputs and obtain all necessary information for the desired cargo transportation without the need for the customer to use multiple sources of information.

Referring to FIG. 2, method 100 begins with a customer making a request for a resource allocation for transporting cargo and ends with the customer obtaining an output with a proposed resource allocation. More particularly, method 100 includes receiving one or more inputs from at least first client device 34 (e.g., at input 36), as indicated by block 102. In embodiments, inputs from client device 34 are representative of desired terms of a subscription or contract (e.g., terms for the resource allocation request). In embodiments, inputs at client device 34 (e.g., at input 36), or desired terms of the contract, may include receiving the origin of a desired shipping lane as indicated by block 104 and a destination of a desired shipping lane as indicated by block 106. For example, an origin of the desired shipping lane may be an address, a city, a state, or another location and the destination of the desired shipping lane may be an address, a city, a state, or another location. Inputs at client device 34 may also include receiving a desired load configuration for the requested lane(s) as indicated by block 108. Load configurations may include a live load or a drop trailer load. A live load may require a driver of a trailer to wait for the trailer to be unloaded and/or loaded at the origin and/or destination and a drop trailer load may require a driver of a trailer to drop and unhook the current trailer and pick up a pre-loaded trailer. The chosen load configuration may be selected for varying reasons including availability of trailers, manpower at the origin and/or destination, type of cargo, or another variable.

Inputs at client device 34 may also include a lane volume as indicated by block 110. Lane volume may be measured as a total number of loads to be carried by the lane over a total contract period. Lane volume may be measured as a number of loads to be carried by the lane over a specific time period (e.g., per week, per month, etc.). Inputs at client device 34 may also include a type of trailer as indicated by block 112. Trailer types may include a specific type of trailer of a specific length. Trailer types may include dry vans, refrigerated trailers, flatbed trailers, curtainside trailers, drop-deck trailers, other types of trailer, tanks, and any other cargo-type option. Inputs at client device 34 may include a load-to-trailer ratio (L/T ratio) defined as the ratio of the number of loads a truck lane is servicing divided by the number of trucks servicing the truck lane over a period of time (e.g., 4 loads completed by 2 trucks per day=2.0 L/T ratio). Inputs at client device 34 may include contract data such as contract length, contract start date, contract end date, or other contract data.

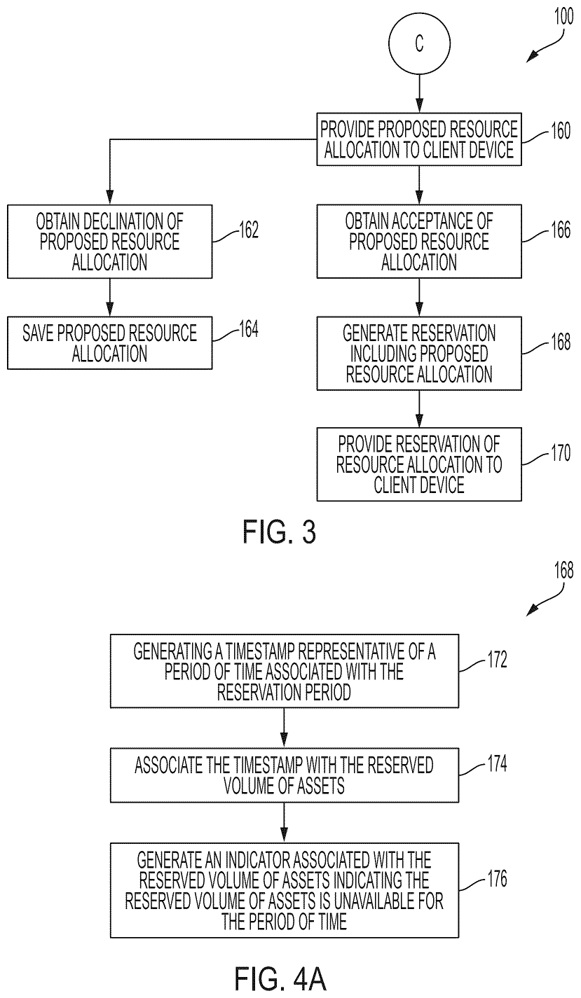

Referring to FIGS. 2-4D, server device 10 obtains user inputs 102 from a client device (e.g., client device 34) as well as data from data sources 50. That is, as shown in FIG. 3, server device 10 obtains data from inventory management data source 54 as indicated by block 118. Server device 10 obtains data from the maintenance and repair data source 52 as indicated by block 120. Server device 10 obtains data from geographic data source 56 as indicated by block 122. Server device 10 obtains data from parking data source 64 as indicated by block 124. Server device 10 obtains data from market data source 60 as indicated by block 126. Server device 10 obtains data from transportation data source 62 as indicated by block 128. Server device 10 obtains data from transportation management system 58 as indicated by block 129.

Referring now to FIGS. 1-4D, server device 10 is operable to create and process a request for resource allocation based on inputs from client devices 34, 40 as well as data sources 50. In embodiments, server device 10 is operable to determine the number of trailers according to the specifications of the contract as indicated by block 130. That is, server device 10 may include instructions, that when executed by inventory manager 18, cause server device 10 to determine the number of trailers according to the specifications of the contract based upon one or more of user inputs 102 and data sources 50.

In embodiments, server device 10 is operable to determine fixed maintenance costs and estimate variable maintenance costs of the trailers needed for service. In embodiments, maintenance costs may be fixed maintenance costs and may be determined or established or may be variable maintenance costs and may be estimated. Fixed maintenance costs may include fluid changes, tire rotations, new tires, or other maintenance procedures that occur at fixed intervals. For example, if a trailer requires a fluid change in 2,000 miles and the trailer will reach that mark during the upcoming contract period, server device 10 may include the cost of the fluid change in the fixed maintenance costs. Variable maintenance costs may include blown tires, unexpected powertrain issues, roadside assistance, or other maintenance procedures that may be unexpected. For example, if a trailer generally requires roadside assistance at a generally average interval of mileage (e.g., one roadside assistance call per 5,000 miles), server device 10 may include the average cost of roadside assistance per trip in the variable maintenance costs. That is, server device 10 may include instructions, that when executed by maintenance manager 28, cause the server device 10 to estimate variable maintenance costs and determine fixed maintenance costs.

Referring to FIG. 2C, method 100 is operable to determine the trailer cost per load, as indicated by block 136. Further, method 100 is operable to determine the driver cost per load, as indicated by block 138. That is, server device 10 may include instructions, that when executed by market manager 20, cause the server device 10 to determine the driver cost per load based upon one or more of user inputs 102 (e.g., lane origin and destination origin) and data sources 50 (e.g., market data).

Referring to FIG. 2C, method 100 is operable to determine the fuel cost per load, as indicated by block 140. That is, server device 10 may include instructions, that when executed by market manager 20, cause the server device 10 to determine the fuel cost per load based upon one or more of user inputs 102 (e.g., lane origin and destination origin) and data sources 50 (e.g., market data).

Referring still to FIG. 2C, method 100 may also include one or more steps to determine additional costs that may be added into the request for resource allocation which may be requested by the client device 32. Method 100 may be operable to determine pre-staging costs of any of trailers 46. Pre-staging a trailer may include parking the trailer in a specific lot, at the loading dock to facilitate a drop load, pre-cooling a refrigeration truck, or otherwise preparing the trailer for use. Pre-staging a trailer may also include moving a trailer or multiple trailers between cities. For example, a customer may require a trailer to be pre-staged in a first city or first region when the nearest available trailer is in a second city or second region, and the cost of moving, or pre-staging the trailer from the second city or region to the first city or region may be included in the pre-staging costs.

Method 100 may be operable to determine insurance costs for the request for resource allocation. Insurance may include insurance to cover damage to the trailers, damage to the trucks, injury to the drivers, damage to the cargo, or other damages, incurred cost, or profit loss. In embodiments, server device 10 may include instructions, that when executed by market manager 20, cause the server device 10 to determine the insurance cost based upon one or more of user inputs 102 (e.g., number of trailers, lane origin and destination) and data sources 50 (e.g., market data). In embodiments, insurance cost may increase as the lane increases in distance. In embodiments, insurance cost may increase if the lane goes through a high-risk crash area. In embodiments, insurance cost may decrease as the lane decreases in distance.

Method 100 may be operable to determine toll costs for the request for resource allocation. In embodiments, server device 10 may include instructions, that when executed by geography manager 26 and/or transportation manager 22, cause the server device 10 to determine the toll costs per lane based upon one or more of user inputs 102 (e.g., number of trailers, lane origin and destination) and data sources 50 (e.g., geographic data 56 and transportation data 62).

Method 100 may be operable to determine parking costs for the request for resource allocation. Parking costs may be incurred during pre-staging, during the lane traversal, at the destination, and during other times of the contract. In embodiments, server device 10 may include instructions, that when executed by parking manager 24, cause the server device 10 to determine the parking costs per lane based upon one or more of user inputs 102 (e.g., number of trailers, lane origin, and destination) and data sources 50 (e.g., parking data 64).

Referring still to FIG. 2C, method 100 calculates an all-in, or total cost per trailer as indicated in block 150. The total cost per trailer may include the trailer cost per load as indicated in block 136, the driver cost per load as indicated in block 138, and the fuel cost per load as indicated in block 140. In embodiments, the total cost per trailer may include the trailer cost per load as indicated in block 136, the driver cost per load as indicated in block 138, the fuel cost per load as indicated in block 140, and one or more of the pre-staging costs as indicated in block 142 (i.e., based in part on one or more of a proximity score using method 180, a utilization score using method 370, and a total score using method 380), insurance costs as indicated in block 144, toll costs as indicated in block 146, and parking costs as indicated in block 148. Method 100 may then process, create, and provide the proposed resource allocation based upon the all-in cost as indicated by block 152. In this way, method 100 and system 2 provide a single platform that allows the customer to have an accurate understanding of the true all-in cost related to various shipping/cargo requests without the need to employ multiple resources and/or manually estimate or collate information. In embodiments, the proposed resource allocation includes the same volume of resources as the requested resource allocation. In embodiments, the proposed resource allocation includes less volume of resources as the requested resource allocation.

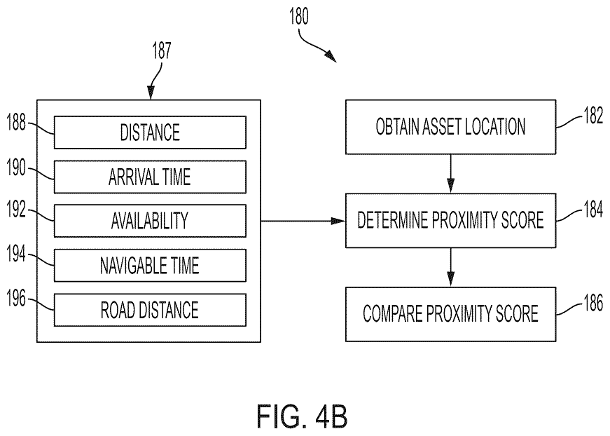

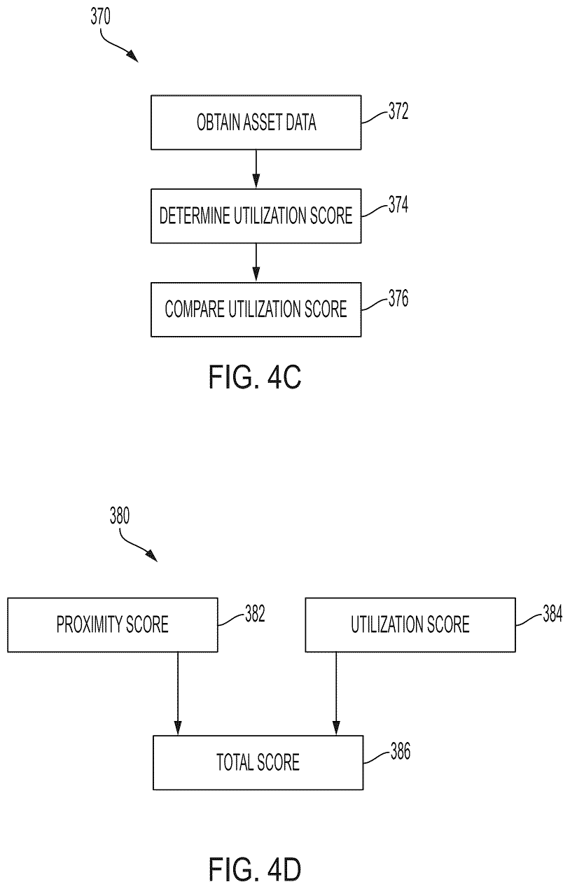

Referring now to FIG. 4B, a method 180 may be utilized to determine the proximity score which may be used to determine pre-staging costs (e.g., block 142). Server 10 may complete method 180 to be utilized with method 100. The proximity score may also be used to determine which assets of the plurality of assets are included in the proposed resource allocation. Method 180 includes determining the location of each asset of the pool of assets (e.g., trailers 46) as indicated in block 182 and determining the proximity score as indicated by block 184. The proximity score may be determined based upon one or more of a plurality of inputs 187. The plurality of inputs 187 may include a distance 188 between an asset of the plurality of assets and the origin or destination. The plurality of inputs 187 may include an arrival time 190 of the asset of the plurality of assets to the origin or destination (e.g., this may include driver time to the asset location and/or time to the origin including traffic, road closures, tolls, etc.). The plurality of inputs 187 may include availability of the asset (i.e., available or unavailable). The plurality of inputs 187 may include a navigable time 194 to the origin or destination from the asset location. The plurality of inputs 187 may include a road distance 196 to the origin or destination from the asset location. Method 180 may determine the proximity score based upon the plurality of inputs 187 as indicated in block 184, and proximity scores may be compared as indicated in block 186. That is, method 180 may determine a first proximity score for a first asset of the plurality of assets (e.g., trailers 46) and a second proximity score for a second asset of the plurality of assets (e.g., trailers 46) and the first proximity score may be compared to the second proximity score to determine which asset has a better proximity, which may be determined based upon physical proximity, temporal proximity, availability, or other characteristics. In embodiments, the proximity score is determined based upon a single input of the plurality of inputs 187. In embodiments, the proximity score is determined based upon a plurality of inputs of the plurality of inputs 187.

Referring now to FIG. 4C, a method 370 may be utilized to determine the utilization score for calculating pre-staging costs (e.g., block 142). Server 10 may facilitate or be involved in the actions of method 370, and method 370 may be utilized with or initiated/completed as part of method 100. The utilization score may also be used to determine which assets of the plurality of assets are included in the proposed resource allocation. Method 370 includes obtaining asset data for one asset of the plurality of assets (e.g., trailers 46) as indicated in block 372. Asset data obtained in block 372 may include data from one or more of data sources 50. Asset data may include specific asset data such as miles driven, miles until next service, number of hours driven, tire pressure, asset dimensions (e.g., trailer length, trailer height, trailer GVW), asset status, number of trips or lanes recorded, time since last utilized, or other asset specific data. Method 370 may determine the utilization score as indicated in block 374 based upon the data obtained in block 372, and utilization scores may be compared as indicated in block 376. That is, method 370 may determine a first utilization score for a first asset of the plurality of assets (e.g., trailers 46) and a second utilization score for a second asset of the plurality of assets (e.g., trailers 46) and the first utilization score may be compared to the second utilization score to determine which asset has a better utilization, which may be determined based upon physical attributes, historical utilization, or other attributes. In embodiments, the utilization score is determined based upon a single data input (e.g., from data sources 50). In embodiments, the utilization score is determined based upon a plurality of data inputs (e.g., from data sources 50).

Referring now to FIG. 4D, a method 380 may be utilized to determine a total score for calculating pre-staging costs (e.g., block 142). Server 10 may facilitate or be involved in the actions of method 380, and method 380 may be utilized with or initiated/completed as part of method 100. The total score may also be used to determine which assets of the plurality of assets are included in the proposed resource allocation. The total score may be determined by combining the proximity score (e.g., block 184 (FIG. 4B)) as indicated in block 382 as well as the utilization score (e.g., block 374 (FIG. 4C)) as indicated in block 384 to create a total score, as shown in block 386. In embodiments, the total score 386 is created by combining, e.g., by mathematical operation, the proximity score 382 and the utilization score 384. In embodiments, the proximity score 382 is added with the utilization score 384. In embodiments, the proximity score 382 is multiplied with the utilization score 384. In embodiments, the proximity score 382 and the utilization score 384 are weighted differently and added together to create the total score 386. Method 380 may determine the total score as indicated in block 386 based upon the proximity score 382 and utilization score 384, and total scores may be compared. That is, method 380 may determine a first total score for a first asset of the plurality of assets (e.g., trailers 46) and a second total score for a second asset of the plurality of assets (e.g., trailers 46) and the first total score may be compared to the second total score to determine which asset has a better total score, which may be determined based upon physical attributes, historical utilization, physical proximity, or other attributes. In embodiments, the total score is determined based upon a single data input (e.g., from data sources 50). In embodiments, the total score is determined based upon a plurality of data inputs (e.g., from data sources 50).

Referring now to FIG. 3, method 100 includes providing the proposed resource allocation to the client device 32 as indicated in block 160. In embodiments, the server device 10 provides, on the network 4, the proposed resource allocation to the client device 32 in the form of a visual output (e.g., on display 200), an audio output, a physical output (e.g., a sheet of printed paper), or another form of output for a user of the user device to view. In embodiments, the client device 32 provides one or more options for a user of the user device to either accept or decline the proposed resource allocation. That is, a user of the user device (e.g., client device 32) may indicate a desire to not use the proposed resource allocation, as indicated by block 162, and sever device 10 may obtain a rejection from the user device. Further, method 100 may subsequently save the proposed resource allocation (e.g., at server device 10) as indicated by block 164. In embodiments, the proposed resource allocation may be saved or stored for a predetermined amount of time (e.g., 6 hours, 12 hours, 1 day, 2 days, 5 days, 10 days, 1 month). Further, a user of the user device (e.g., client device 32) may indicate a desire to use the proposed resource allocation, as indicated by block 166, and server device 10 may obtain an acceptance from the user device. Server device 10 may then generate a reservation, as indicated by block 168, that includes the proposed resource allocation and subsequently provide an indication of the reservation to the user device 32 as indicated by block 170. In embodiments, the reservation is provided in the form of a visual output (e.g., on display 200), an audio output, a physical output (e.g., a sheet of printed paper), or another form of output for a user of the user device to view.

Referring now to FIG. 4A, block 168 is a sub-process of method 100 for generating the reservation at the server device 10. In embodiments, sub-process 168 includes generating a timestamp representative of a period of time associated with the length of the reservation (e.g., contract length) as indicated by block 172. In embodiments, the timestamp includes a starting time representative of the start of the contract and an ending time representative of the end of the contract. Method 100 may associate the timestamp with a subset of assets (e.g., trailers) to fulfill the proposed resource allocation to create a reserved volume of assets, as indicated by block 174. In embodiments, the reserved volume of assets is created using the proximity score (i.e., method 180; FIG. 4B). That is, the reserved volume of assets may be created using a set of assets among the plurality of assets 46 with the best proximity score. In embodiments, the reserved volume of assets is created using the utilization score (i.e., method 370; FIG. 4C). That is, the reserved volume of assets may be created using a set of assets among the plurality of assets 46 with the best utilization score. In embodiments, the reserved volume of assets is created using the total score (i.e., method 386; FIG. 4D). That is, the reserved volume of assets may be created using a set of assets among the plurality of assets 46 with the best total score. Method 100 may also generate an indicator associated with the reserved volume of assets as indicated by block 176. The indicator associated with the reserved volume of assets may indicate that the reserved volume of assets is unavailable for the period of time associated with the time stamp. In embodiments, server device 10 may provide, over the network 4, the indicator associated with the reserved volume. In embodiments, any unreserved volume of assets is assigned an indicator indicating that the volume of assets is available. One or more client devices (e.g., client device 40) may query server device 10 for a status of the plurality of assets 46 and obtain a status (e.g., available or unavailable) of the assets 46.

A general order of the operations for the method 100 is shown in FIGS. 2-4. Generally, method 100 begins with receiving user inputs 102. Method 100 may include more or fewer steps or may arrange the order of the steps differently than those shown in FIGS. 2-4.

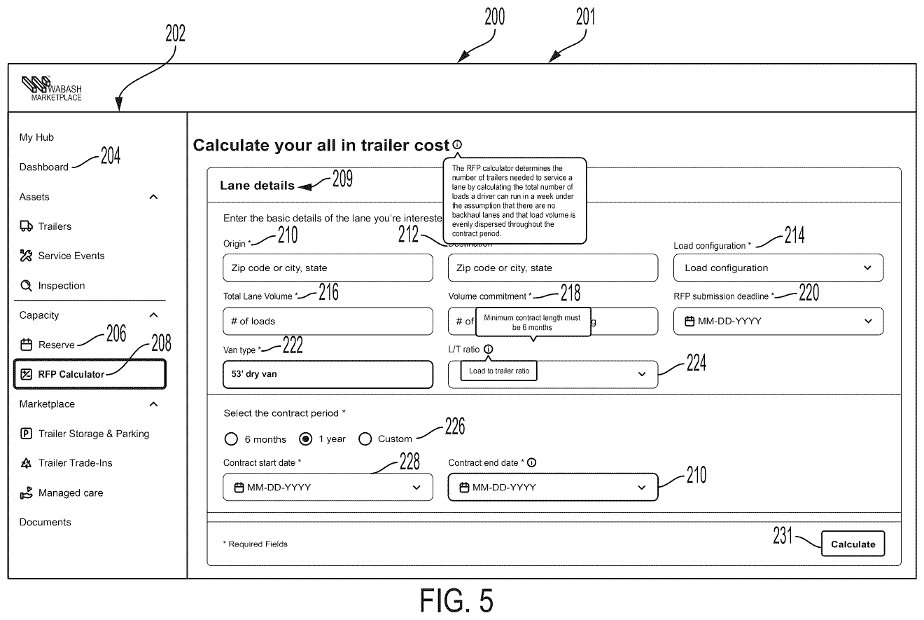

Referring now to FIGS. 5-9, a user of a client device 32 (e.g., client device 34) may access a display 200 (e.g., output 38) which may be a webpage or an application displayed on output 38 of client device 34. Referring to FIG. 5, display 200 may display a first screen layout 201 including a menu or sidebar 202 and the sidebar includes a plurality of tabs. The plurality of tabs may include a first tab or dashboard tab 204, a second tab or reservation tab 206, and a third tab or Request for Proposal calculator tab 208. Sidebar 202 may include other tabs to navigate between a plurality of screen layouts.

First screen layout 201 includes a display section 209 which includes a plurality of inputs or fillable text boxes to obtain data for processing and submitting the request for resource allocation. A first input 210 obtains a user input of the desired origin of the lane (i.e., step 104, FIG. 2) and a second user input 212 obtains a user input of the desired destination of the lane (i.e., step 106, FIG. 2). Display section 209 includes a third input 214 to obtain a load configuration (i.e., step 108, FIG. 2), a fourth input 216 to obtain a total lane volume and a fifth input 218 to obtain a volume commitment (i.e., step 110, FIG. 2). Display section 209 also includes a sixth input 220 indicating a user deadline for submitting the request for resource allocation. Display section 209 also includes a seventh input 222 to obtain a van type desired by the request for resource allocation (i.e., step 112, FIG. 2) and an eighth input 224 to obtain a Load-to-Trailer (L/T) ratio (i.e., step 114, FIG. 2). In embodiments, display section 209 includes a ninth input 226 to obtain a preferred contract length period (i.e., step 116, FIG. 2). In embodiments, ninth input 226 includes one or more discrete inputs (e.g., radio buttons indicating 6-months or 1-year). In embodiments, ninth input 226 includes a continuous input or a calendar input for a custom input. In embodiments, display section 209 includes a tenth input 228 to obtain a contract start date (i.e., step 116, FIG. 2) and an eleventh input 230 to obtain a contract end date (i.e., block 118, FIG. 2). In embodiments, tenth input 228 and eleventh input 230 includes a continuous input or a calendar input for a custom input. Display section 209 also includes a calculate or proceed input 231 which will provide the inputs from display section 209 (i.e., first input 210 through eleventh input 230) to the server device 10.

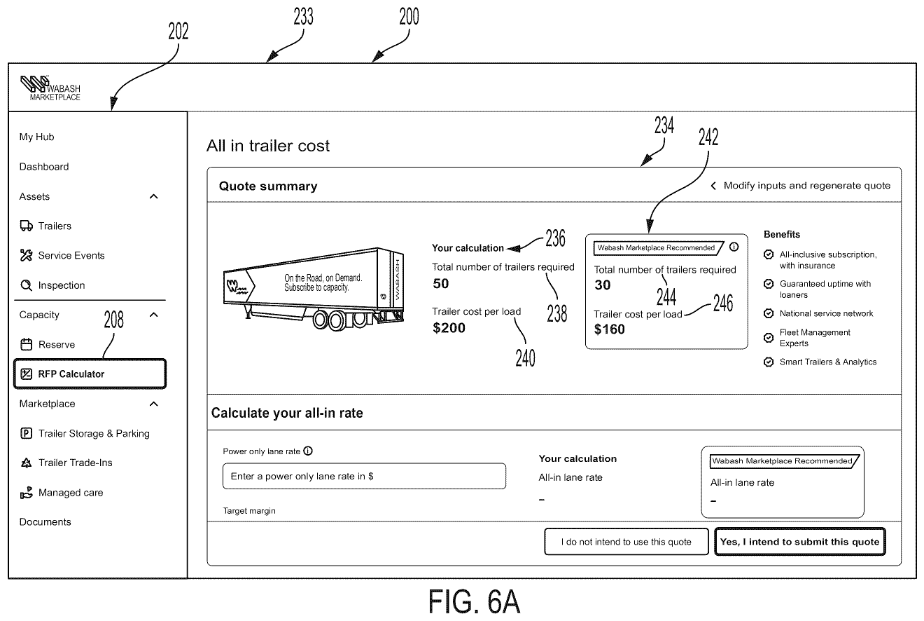

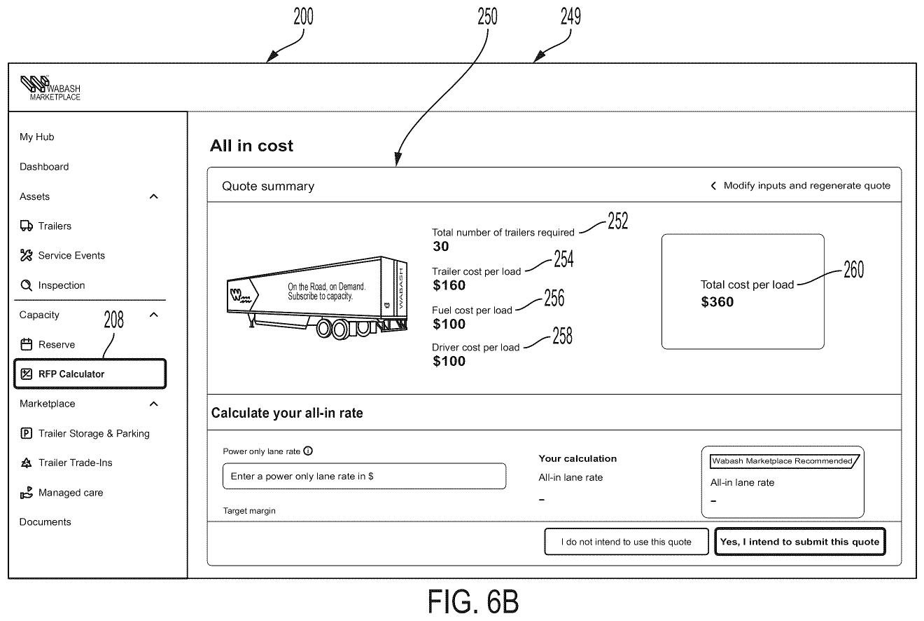

Referring now to FIG. 6A, server device 10 obtains inputs from the plurality of inputs within display section 209 and calculates the trailer cost per load utilizing one or more of inventory manager 18, market manager 20, transportation manager 22, parking manager 24, geography manager 26, maintenance manger 28, and TMS manager 30 and display the output within a display section 234 on a second screen layout 233. Display 200 may display the second screen layout 233 on client device 34 (e.g., output 38) and may display the display section 234 including a first subsection 236 and a second subsection 242. First subsection 236 may include a first set of numbers indicating a projected volume of assets anticipated and a projected trailer cost per load if the user of the client device sourced the trailers without system 2 and method 100 including a first estimated volume of assets (e.g., number of trailers) 238 and a first trailer cost per load 240. Second subsection 242 may include a second set of numbers indicating a recommendation including a second estimated volume of assets (e.g., number of trailers) 244 and a second trailer cost per load 246 if the user of the client device sourced the trailers using system 2 and method 100 including a second estimated volume of assets 244 and a second trailer cost per load 246. Second estimated volume of assets 244 of the second subsection 242 is the output of step 130 of method 100 (FIG. 4) and the second trailer cost per load 246 of the second subsection 242 is the output of step 136 of method 100 (FIG. 4). That is, the first subsection 236 may be representative of a standard proposed resource allocation and second subsection 242 may be representative of a calculated proposed resource allocation using system 2 and method 100, and displaying the first subsection 236 and second subsection 242 adjacent one another allows a user to view an asset or cost benefit of using the calculated proposed resource allocation from system 2 and method 100.

Referring now to FIG. 6B, an alternate display section 250 may be displayed instead of display section 234. That is, server device 10 may obtain inputs from the plurality of inputs within display section 209 and calculates the trailer cost per load utilizing one or more of inventory manager 18, market manager 20, transportation manager 22, parking manager 24, geography manager 26, maintenance manger 28, and TMS manager 30 and display the output within alternate display section 250 on an alternate second screen layout 249 on display 200 (e.g., output 38). Display section 250 may include the total estimated volume of assets (e.g., total number of trailers anticipated) as indicated by section 252 (i.e., from block 130, FIG. 4), the trailer cost per load as indicated by section 254 (i.e., from block 136, FIG. 4), the fuel cost per load as indicated by section 256 (i.e., from block 138, FIG. 4), and the driver cost per load as indicated by section 258 (i.e., from block 140, FIG. 4). Display section 250 may also display the total cost per load as indicated by section 260 (i.e., from block 150, FIG. 4).

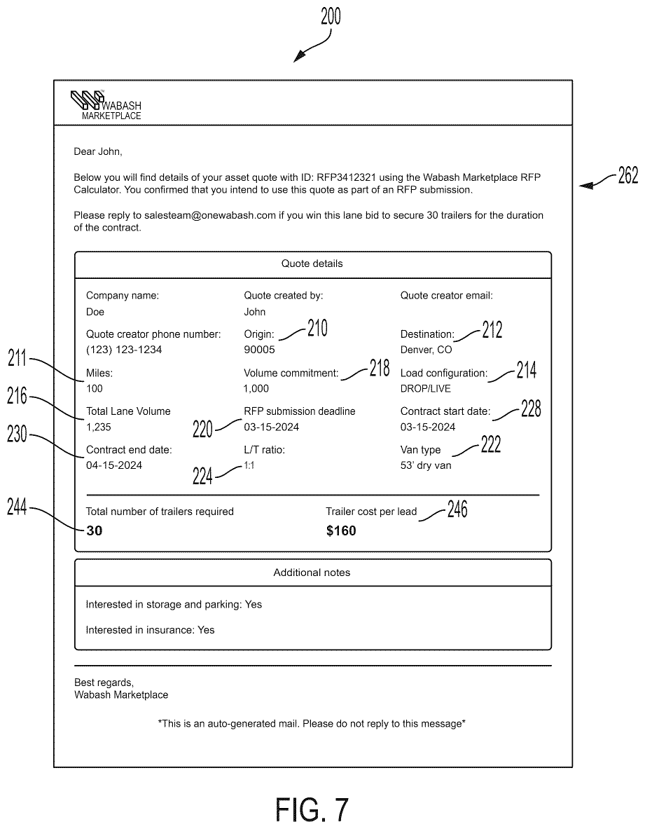

Referring now to FIG. 7, server device 10 may send a confirmation email to client device 32 and display it on display 200 (e.g., output 38 of client device 34). Display 200 may be configured to display a screen layout 262 which may be an email confirmation displayed on a webpage or in an application such as an email client. Screen layout 262 may include relevant details from the request for resource allocation as well as the proposed resource allocation (e.g., estimated asset volume 244 and trailer cost per load 246). Screen layout 252 may also include other information such as fuel cost per load 256 and driver cost per load 258.

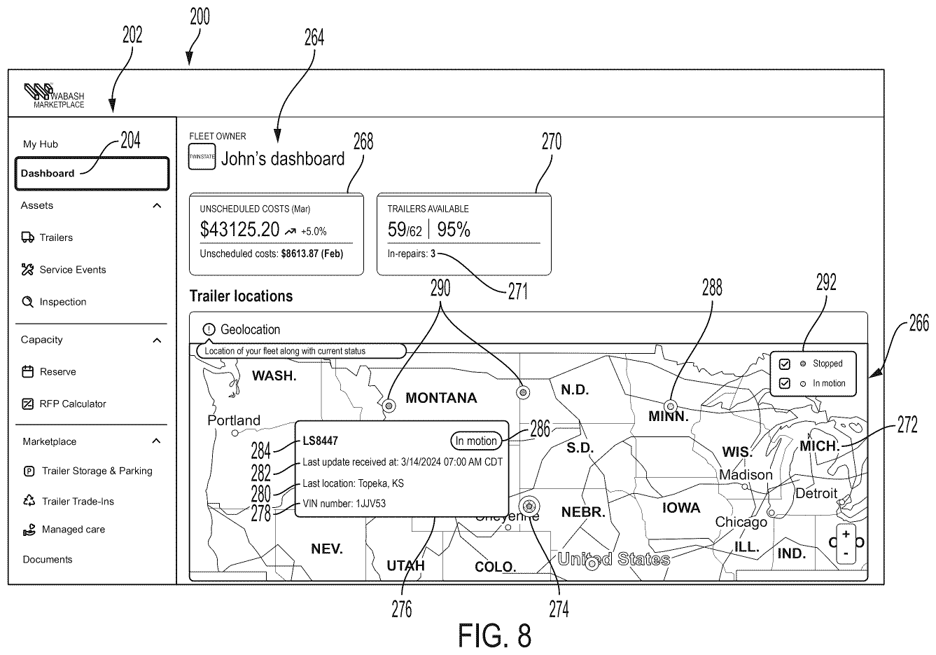

Referring now to FIG. 8, client device 10 may display on display 200 (e.g., output 38) a screen layout 264. Screen layout 264 may be a dashboard screen layout associated with tab 204 on sidebar 202. Dashboard screen layout 264 may include a first section 266, a second section 268, and a third section 270 which may be displayed simultaneously and adjacent one another. In embodiments, first section 266 includes geographical data about the plurality of trailers 46 displayed on a map 272. Map 272 may be a regional map including a region, a city, a group of cities, a state, a group of states, or a country. A plurality of indicators may be positioned on map 272 and may be representative of respective locations of the plurality of trailers 46. That is, server device 10 may obtain data from TMS 58 that when interpreted by TMS manager 30, allows client device 32 to see the locations of the plurality of vehicles 46. In embodiments, client device 32 may interface directly with TMS 58 to obtain the locations of the plurality of trailers 46.

In embodiments, a first indicator 274 may be selected and a display box 276 may pop-up and display relevant information about the vehicle represented by first indicator 274. Display box 276 may be a text box including the trailer VIN 278, the last identified location of the trailer 280, the time the last update was obtained 282, a group number 284, and a status indicator 286. Status indicator 286 may be one of a plurality of statuses and may be an ‘In Motion’ status indicating the trailer is currently moving, may be a ‘Not Moving’ status indicating the trailer is currently not in motion, and a ‘Maintenance’ status indicating the trailer is not usable and is currently being worked on or scheduled to be worked on. The plurality of indicators may also include indicator 288 which has a first notification, such as color (e.g., green), indicating the vehicle is moving without opening the display box 276. The plurality of indicators may also include indicators 290 which have a second notification, such as color (e.g., red), indicating the vehicle is not moving without opening the display box 276. A legend 292 may also be located on map 272 providing information on the indicators 274, 288, 290.

Referring still to FIG. 8, second section 268 of screen layout 264 may include an indicator representative of unscheduled costs. Unscheduled costs may include variable maintenance costs and other unexpected costs. Third section 670 of screen layout 264 may include an indicator representing how many trailers are available, or in-use, as a fraction of the number of total trailers. Third section 670 may also include an indicator 271 representative of the number of trailers currently in maintenance. That is, server device 10 may obtain maintenance and repair data 52 that when interpreted by the maintenance manager 28, allows client device 32 to see the maintenance status of the plurality of vehicles 46. In embodiments, client device 32 may directly obtain the maintenance data 52 from inputs 50 to obtain the maintenance status of the plurality of trailers 46.

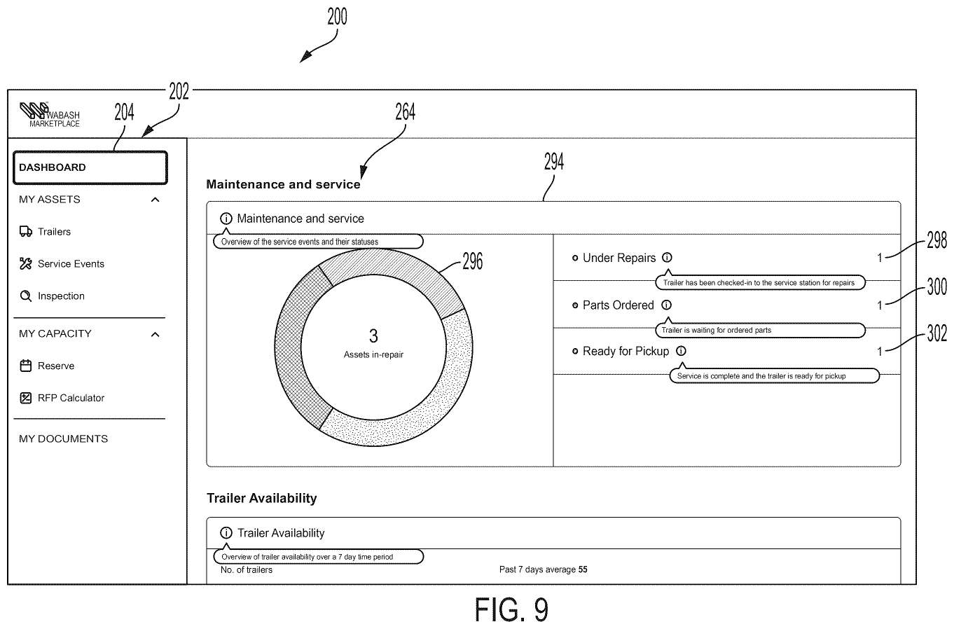

Referring now to FIG. 9, dashboard screen layout 264 may also include a fourth section 294 which may be representative of maintenance and service of the plurality of trailers 46. Fourth section 294 may include a graphical representation 296 of the status of the plurality of trailers 46 in maintenance (e.g., associated with indicator 271). Fourth section 294 may include a plurality of status descriptors including a first status descriptor 298 indicating the number of trailers 46 under repair, a second status descriptor 300 indicating the number of trailers 46 with parts on order, and a third status descriptor 302 indicating the number of trailers 46 ready for pickup.

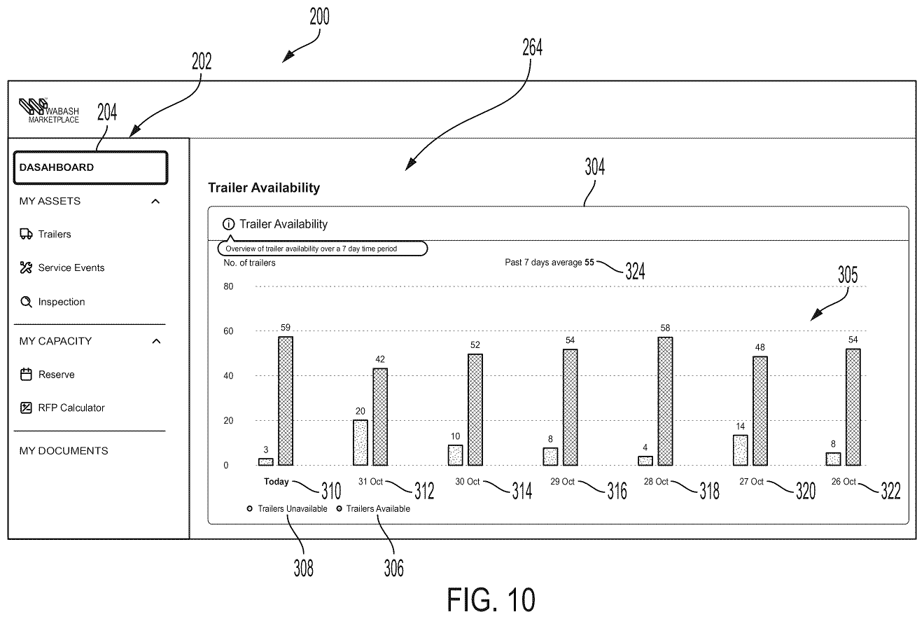

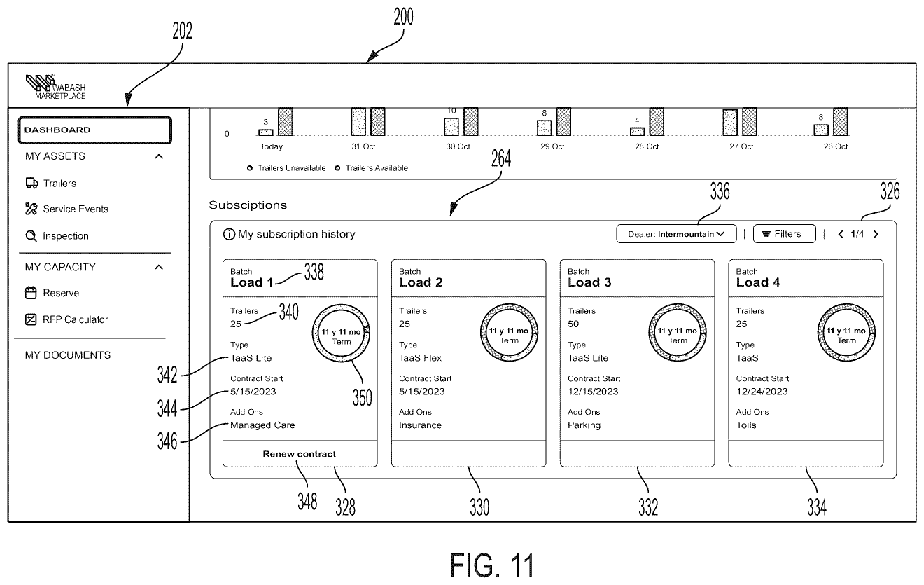

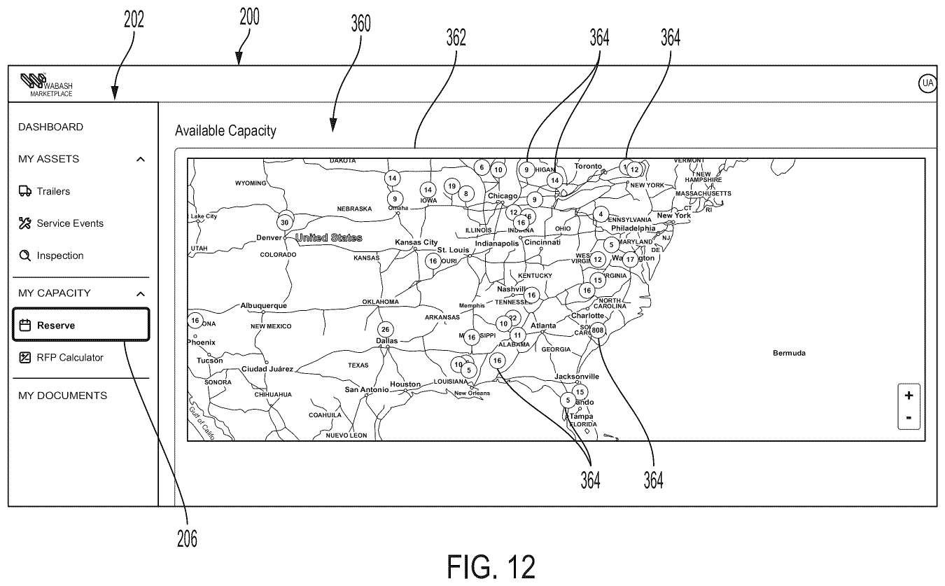

Referring now to FIG. 10, dashboard screen layout 264 may also include a fifth section 304 which may be representative of availability over time of the plurality of trailers 46. Fifth section 304 may include a graphical representation 305 indicating the historical availability of the plurality of trailers 46. Graphical representation 305 may include a first indicator 306 indicating a portion of trailers 46 that are currently available and a second indicator 308 indicating a portion of trailers 46 that are currently unavailable. Graphical representation 305 may include a first data set 310 including the number of trailers 46 available and unavailable for the current day. Graphical representation 305 may also include a second data set 312 representative of a previous time period (e.g., yesterday), a third data set 314 representative of a previous time period (e.g., 2 days ago), a fourth data set 316 representative of a previous time period (e.g., 3 days ago), a fifth data set 318 representative of a previous time period (e.g., 4 days ago), a sixth data set 320 representative of a previous time period (e.g., 5 days ago), and a seventh data set 322 representative of a previous time period (e.g., 6 days ago). In embodiments, fifth section 304 may also include an indicator 324 representative of an average number of trailers 46 that have been available. That is, server device 10 may obtain maintenance and repair data 52 that when interpreted by the maintenance manager 28, allows client device 32 to see the maintenance status of the plurality of vehicles 46 and server device 10 may store historical data regarding the maintenance status of the plurality of vehicles 46. In embodiments, client device 32 may directly obtain the maintenance data 52 from inputs 50 to obtain the maintenance status of the plurality of trailers 46.

Referring now to FIG. 11, dashboard screen layout 264 may also include a sixth section 326 which may be representative of current and past contracts or subscriptions. Sixth section 326 may include an indicator of a first or current subscription 328, a second subscription 330, a third subscription 332, and a fourth subscription 334. In embodiments, all subscriptions may be shown or only a few subscriptions may be shown at a single time. In embodiments, sixth section 326 includes a dropdown box 336 and a user may sort the subscriptions by which dealer the subscription is through. Each subscription indicator (i.e., indicators 328, 330, 332, 334) includes data representative of the subscription. Data within each subscription indicator may include a name of the subscription 338, the number of trailers 340 in the subscription, the type of subscription 342, the start date of the contract 344, and if there are any add-ons to the subscription at indicator 346 (e.g., insurance). Data within each subscription indicator may also include a graphical and/or numerical indicator 350 of the term left on the subscription. Each subscription indicator (i.e., indicators 328, 330, 332, 334) may also include an input 348 to renew or review the terms of the subscription and extend the term of the subscription, alter the volume of assets (e.g., number of trailers) for the subscription, or otherwise alter the subscription.

Referring now to FIG. 12, client device 10 may display on display 200 (e.g., output 38) a screen layout 360. Screen layout 360 may be a reservation screen layout associated with tab 206 on sidebar 202. Screen layout 360 may include a map 362 and a plurality of indicators 364 positioned on the map 362. Map 362 may be a regional map, a state map, or a country map, or may be navigable between regions, states, or countries. Indicators 364 may include a number representative of the number of trailers 46 available at the location of the indicator 364 on the map 362.

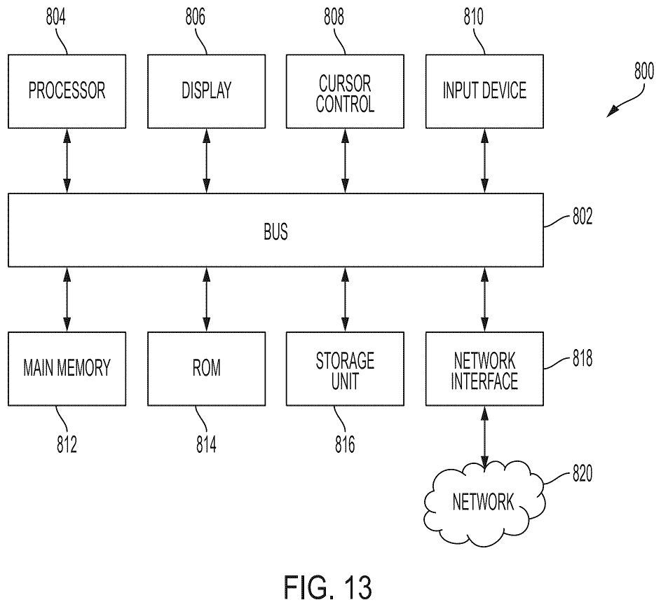

FIG. 13 illustrates a diagram of a computing system 800 for implementing aspects of system control and method execution according to aspects described herein. This diagram is merely an example, which should not unduly limit the scope of the claims. One of ordinary skill in the art would recognize many variations, alternatives, and modifications.

The computing system 800 includes a bus 802 or other communication mechanism for communicating information between, a processor 804, a display 806, a cursor control component 808, an input device 810, a main memory 812, a read only memory (ROM) 814, a storage unit 816, and/or a network interface 818. In some examples, bus 802 is coupled to the processor 804, display 806, cursor control component 808, input device 810, main memory 812, read only memory (ROM) 814, storage unit 816, and/or network interface 818. And, in certain examples, network interface 818 is coupled to a network 820 such as wi-fi or other wireless networks.

In some examples, processor 804 includes one or more general purpose microprocessors. In some examples, main memory 812 (e.g., random access memory (RAM), cache and/or other dynamic storage devices) is configured to store information and instructions to be executed by processor 804. In certain examples, main memory 812 is configured to store temporary variables or other intermediate information during execution of instructions to be executed by processor 804. For example, the instructions, when stored in storage unit 816 accessible to processor 804, render computing system 800 into a special-purpose machine that is customized to perform the operations specified herein. In some examples, ROM 814 is configured to store static information and instructions for processor 804. In certain examples, storage unit 816 (e.g., a magnetic disk, optical disk, or flash drive) is configured to store information and instructions.

Thus, computing system 800 may include at least some form of computer readable media. The computer readable media may be any available media that can be accessed by processor 804 or other devices. For example, the computer readable media may include computer storage media and communication media. The computer storage media may include volatile and nonvolatile, removable and non-removable media implemented in any method or technology for storage of information such as computer readable instructions, data structures, program modules or other data. The computer storage media may not include communication media.

In some embodiments, display 806 (e.g., a cathode ray tube (CRT), an LCD display, or a touch screen) is configured to display information to a user of the computing system 800. In some examples, the input device 810 (e.g., alphanumeric and other keys) is configured to communicate information and commands to the processor 804. For example, the cursor control 808 (e.g., a mouse, a trackball, or cursor direction keys) is configured to communicate additional information and commands (e.g., to control cursor movements on the display 806) to the processor 804.

In embodiments, a first client device 32 (e.g., client device 34) may be operably coupled to client transportation management system (client TMS) 70. Client TMS 70 may include data regarding a third party fleet of trailers 71 (e.g., similar to trailers 46) to allow another client device 32 (e.g., second client device 40) to access information about the third party fleet of trailers 71. Server device 10 may be operable to access information about the third party fleet of trailers 71. The second client device 32 (e.g., client device 40) may utilize method 100 to create a request for resource allocation and obtain a proposed resource allocation to utilize the third party fleet of trailers 71 to satisfy the customer lane requirements. The second client device 32 (e.g., client device 40) may utilize method 100 to create a request for resource allocation and obtain a proposed resource allocation to utilize the third party fleet of trailers 71 and the first plurality of trailers 46 to satisfy the customer lane requirements.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A method of resource orchestration for cargo vehicles, comprising:
receiving a plurality of user inputs, the plurality of inputs including geographical data associated with a lane of travel and a desired volume of assets for traveling on the lane of travel;
obtaining a plurality of data sets, the plurality of data sets including a first data set associated with the lane of travel and a second data set associated with a pool of assets;
generating, based upon the plurality of data sets and the plurality of user inputs, a proposed resource allocation including a proposed volume of assets for traveling on the lane of travel; and
providing, to a user computing device, an indication of the proposed resource allocation for display to a user of the user computing device.

2. The method of claim 1, further comprising:
receiving, from the user computing device, an acceptance of the proposed resource allocation;
generating a reservation including a reserved volume of assets based upon the proposed volume of assets from the pool of assets; and
providing, to the user computing device, an indication of the reserved volume of assets for display to a user of the user computing device.

3. The method of claim 2, wherein the generating a reservation step includes:
generating a timestamp representative of a period of time for the volume of assets; and
marking the volume of assets as unavailable for the period of time.

4. The method of claim 1, wherein the pool of assets includes a first asset in a first region and a second asset in a second region.

5. The method of claim 1, wherein the plurality of data sets includes information about a location of an asset of the pool of assets.

6. The method of claim 1, further comprising:
determining, based upon a first location of a first asset of the pool of assets and a second location of a second asset of the pool of assets, a relative proximity score of each of the first asset and the second asset; and
wherein the generated proposed resource allocation includes at least one of the first asset and the second asset based upon the determined proximity score of each of the first asset and the second asset.

7. The method of claim 1, further comprising:
determining, based upon at least one data set of the plurality of data sets, a relative utilization score of each of the first asset and the second asset; and
wherein the generated proposed resource allocation includes at least one of the first asset and the second asset based upon the determined utilization score of each of the first asset and the second asset.

8. A system, comprising:
at least one processor; and
a memory comprising instructions that, when executed by the at least one processor, cause the system to perform a set of operations, the set of operations comprising:
receiving a plurality of user inputs, the plurality of inputs including geographical data associated with a lane of travel and a desired volume of assets for traveling on the lane of travel;
obtaining a plurality of data sets, the plurality of data sets including a first data set associated with the lane of travel and a second data set associated with a pool of assets;
generating, based upon the plurality of data sets and the plurality of user inputs, a proposed resource allocation including a proposed volume of assets for traveling on the lane of travel; and
providing, to a user computing device, an indication of the proposed resource allocation for display to a user of the user computing device.

9. The system of claim 8, wherein the set of operations further comprises:
receiving, from the user computing device, an acceptance of the proposed resource allocation;
generating a reservation including a reserved volume of assets based upon the proposed volume of assets from the pool of assets; and
providing, to the user computing device, an indication of the reserved volume of assets for display to a user of the user computing device.

10. The system of claim 9, wherein the generating a reservation step of the set of operations further comprises:
generating a timestamp representative of a period of time for the volume of assets; and
marking the volume of assets as unavailable for the period of time.

11. The system of claim 8, wherein the plurality of data sets includes a location of an asset of the pool of assets.

12. The system of claim 8, wherein the proposed volume of assets is equal to or less than the desired volume of assets.

13. The system of claim 8, wherein the set of operations further comprises:
determining, based upon a first location of a first asset of the pool of assets and a second location of a second asset of the pool of assets, a relative proximity score of each of the first asset and the second asset; and
wherein the generated proposed resource allocation includes at least one of the first asset and the second asset based upon the determined proximity score of each of the first asset and the second asset.

14. The system of claim 8, wherein the set of operations further comprises:
determining, based upon at least one data set of the plurality of data sets, a relative utilization score of each of the first asset and the second asset; and
wherein the generated proposed resource allocation includes at least one of the first asset and the second asset based upon the determined utilization score of each of the first asset and the second asset.

15. A method of resource orchestration for cargo vehicles, comprising:
receiving a plurality of user inputs, the plurality of inputs including an origin and a destination associated with a lane of travel and a desired volume of assets for traveling on the lane of travel;
obtaining a plurality of data sets, the plurality of data sets including a first data set associated with location data of a pool of assets, the pool of assets including a first asset positioned at a first location spaced a first distance from the origin and a second asset positioned at a second location spaced a second distance from the origin;
determining, based upon the first distance and the second distance, a respective proximity score for each of the first asset and the second asset;
generating, based upon the plurality of data sets, the plurality of user inputs, and the proximity score of each of the first asset and the second asset, a proposed resource allocation including a proposed volume of assets for traveling on the lane of travel, the proposed volume of assets including at least one of the first asset and the second asset; and
providing, to a user computing device, an indication of the proposed resource allocation for display to a user of the user computing device.

16. The method of claim 15, wherein the proximity score is further based upon a respective navigable time between the origin and each of the first location and the second location.

17. The method of claim 15, wherein the proximity score is further based upon a respective earliest asset arrival time of each of the first asset and the second asset.

18. The method of claim 15, further comprising:
receiving, from the user computing device, an acceptance of the proposed resource allocation;
generating a reservation including a reserved volume of assets based upon the proposed volume of assets from the pool of assets; and
providing, to the user computing device, an indication of the reserved volume of assets for display to a user of the user computing device.

19. The system of claim 18, wherein the generating a reservation step of the set of operations further comprises:
generating a timestamp representative of a period of time for the volume of assets; and
marking the volume of assets as unavailable for the period of time.

20. The system of claim 15, wherein the proposed volume of assets is equal to or less than the desired volume of assets.
